(19) United States
(12) Patent Application Publication
(10) Pub. No.: US 2003/0000516 A1
(43) Pub. Date: Jan. 2, 2003

(54) Foldable Supporting frame

(75) Inventors: Ching-Hui Hsu, Taipei (TW); Shan-Pao Chu, Shenzhen City (CN)

Correspondence Address: BACON & THOMAS, PLLC, 625 SLATERS LANE, FOURTH FLOOR, ALEXANDRIA, VA, 22314

(73) Assignee: Test Rite International Company, Ltd., Taipei (TW)

(21) Appl. No.: 10/157,108

(22) Filed: May 30, 2002

(30) Foreign Application Priority Data
Jun. 29, 2001 (CN) 01 2 27382.1

(51) Int. Cl. A47J 37/00; F24B 3/00

(52) U.S. Cl. 126/25 R; 126/276; 126/40

(57) ABSTRACT

A foldable supporting frame, comprising left and right supporting rods and a connecting rod in the middle; the supporting rods and the connecting rod can be pivotally connected. When folded, the supporting rods can be superposed on the connecting rod, forming a folded structure occupying limited space. When stretching the foldable supporting frame, the user only needs to stretch the supporting rods pivoted by the connecting pivots toward the two sides, thus the foldable supporting frame can be fully stretched and ready to be used. A grill body can be placed on top of the foldable supporting frame of the present invention, forming a grill with foldable supporting frame. The foldable supporting frame of the present invention, after using, can be fully folded through procedures in reverse of the aforementioned procedures for stretching.

### BACKGROUND OF THE INVENTION

1. FIELD OF THE INVENTION

The foldable supporting frame of the present invention uses pivots to connect the folding mechanism of the connecting rod and the supporting rods, thus replacing the assembly means of utilizing huge amount of screws employed by the prior arts, so as to accomplish the effects of easy assembly and disassembly as well as time-saving and convenience.

2. DESCRIPTION OF THE RELATED ART

Since the advent of industrialization, the societal progress has been everlasting; it has especially become difficult for people nowadays to freely relax as the social competition and pressure heighten degree by degree. Thus, recreational activities able to release pressure are desperately sought after by work-laden people. However, domestic or overseas traveling and vacationing cost money, therefore are not affordable for all working people and students; in addition, it takes time to do domestic or overseas traveling and vacationing, for at least one or two days are necessary, some trips even take weeks to complete. As a result, for most work-laden people with limited resources of time and money, having barbecue is undoubtedly the best choice for them to relax and recuperate out of the constant pressure, since it costs much less in terms of time and money, and suitable for participation by the whole family members.

As to the different design of grills provided in the market, the earliest type of the grill is of a fixated grill, with the grill body and supporting frame formed integrally. Such a grill causes inconvenience for the user by its cumbersome volume. Later on, such kind of fixated grill is improved by a grill assembly, which includes detachable grill body and the supporting frame jointed by screws, and can be detached after use, thus improving the drawback of the foregoing fixated grill that causes inconvenience for the user by its cumbersome volume.

The grill 2, as shown in FIG. 1, mainly includes a grill body 21 and a supporting frame 22; the supporting frame 22 comprises frame supports 221, supporting rods 222 and connecting rods 223, and screws 23 are used to joint such three components, and then the grill body 21 is placed on top of the supporting frame 22, thus completes the assembly of the grill 2.

Nevertheless, because of the complicated structure of the grill 2, a volume of complicated instruction manual must be enclosed with the grill 2. In addition, the user, after purchasing such a grill 2, must read the instruction manual carefully and complete the assembly step by step, a means of assembly that not only causes difficulty, but is also time-consuming, for user must spend great deal of time in both reading the manual and assembling the grill 2. Thus, for those consumers who are not familiar with such technique, the grill 2 is to cause difficulty and inconvenience, and even prevents the user from successfully completing the assembly process.

Therefore, the assembly grill 2 of the prior art though is designed to improve upon the drawback of the conventional grill's cumbersome volume that causes difficulty and inconvenience for the user to carry or store, it also causes problems out of complicated assembly process due to too many screw parts and thus time-consuming. The present invention, as a result, is to provide a design that simultaneously improves upon the drawbacks existed in the aforementioned prior arts; with a foldable supporting frame, the grill assembly equips with the advantages of easy assembly and disassembly, convenient to carry and not occupying too much space.

### SUMMARY OF THE INVENTION

The main object of the invention is to provide a foldable supporting frame, comprising the left and right supporting rods and a connecting rod in the middle; such supporting rods and connecting rod are jointed by pivots, and when folding, the supporting rods are superposed on the connecting rod, thus forming a flat structure that occupies limited space. When using, the user only needs to stretch the supporting rods pivoted by the connecting pivots toward the two sides, thus the foldable supporting frame can be fully stretched and ready to be used. At the upper ends of the supporting rods in the present invention, fixating bolts are installed so that the grill body can be installed thereupon by placing the narrow reversed-V-shape grooves of the grill body into the fixating bolts, thus completing the assembly. When disassembling, the user only has to reverse the aforementioned steps of assembly to complete the steps of disassembly.

When the present invention is fully stretched, a strengthening frame can be placed on top of the upper ends of the supporting rods, with the stopping portions to hold the supporting rods at both sides, thus the supporting frame of the present invention can be aligned and strengthened.

### BRIEF DESCRIPTION OF THE DRAWINGS

These and other features, aspects and advantages of the present invention will become better understood with regard to the following description, appended claims and accompanying drawings where:

FIG. 1 shows a front side view of the grill of the prior art;

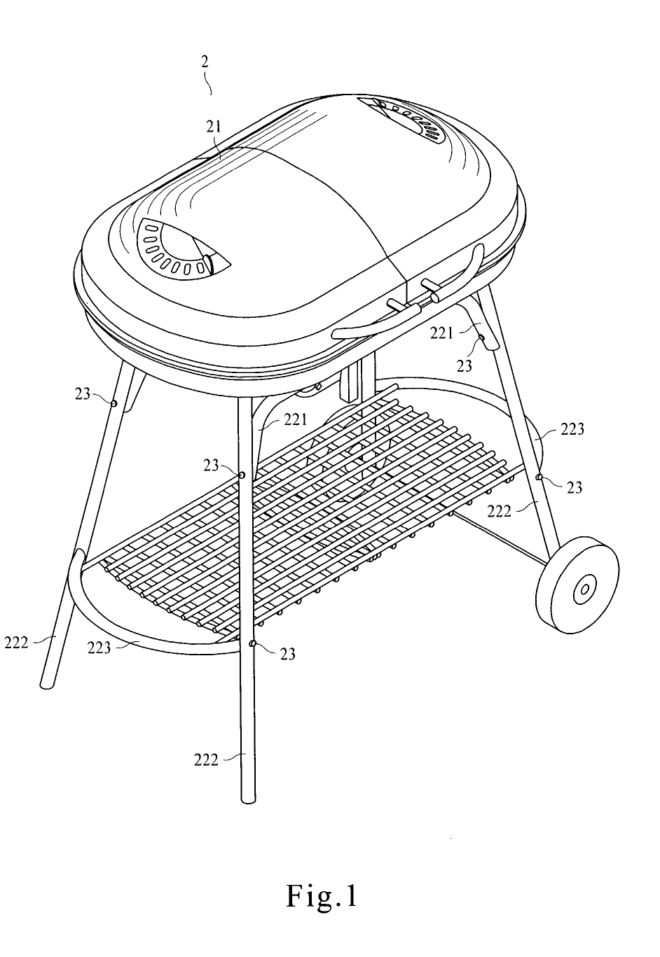

FIG. 2A shows a structural perspective view of the foldable supporting frame of the present invention being folded;

FIG. 2B shows a structural perspective view of the foldable supporting frame of the present invention being stretched;

FIG. 3 shows a side view of the first embodiment of the foldable supporting frame of the present invention;

FIG. 4 shows a side view of the second embodiment of the foldable supporting frame of the present invention;

FIG. 5 shows a side view of the third embodiment of the foldable supporting frame of the present invention; and

FIG. 6 shows a side view of the embodiment of the foldable supporting frame of the present invention.

### DETAILED DESCRIPTION OF THE PREFERRED EMBODIMENTS

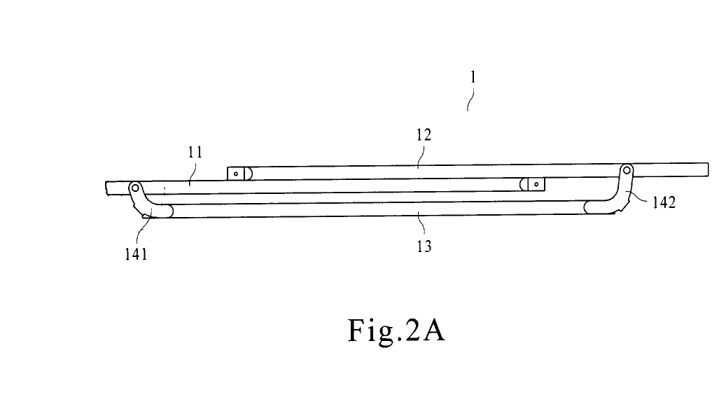

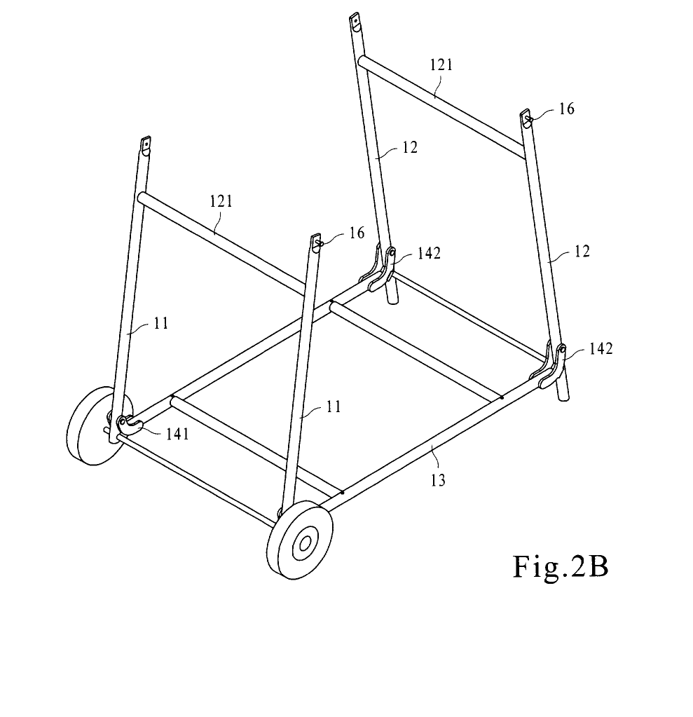

As shown in FIG. 2A and 2B, which show respectively the structural perspective view of the folded and stretched foldable supporting frame of the present invention, the foldable supporting frame 1 mainly includes supporting rods 11 and 12 and a connecting rod 13; the connecting rod 13 is a horizontally installed frame, and the supporting rods 11 and 12 are independent plain-surface frames installed at the two sides of the connecting rod 13 respectively, with pivots 141 and 142 connecting the supporting rods 11 and 12 to the connecting rod 13, thus the supporting rods 11 and 12 can be moved by using pivots 141 and 142 as pivots, to be folded inward (as shown in FIG. 2A) or to be stretched outward (as shown in FIG. 2B).

Please continue referring to FIG. 2A. In the foldable supporting frame 1 of the present invention, the supporting rods 11 and 12, under folding condition, are folded inward to right and left respectively and superposed on top of the connecting rod 13, thus forming a minimum-height structure that, formed by superposing rods, occupies limited space. When using, the foldable supporting frame 1 of the present invention can be stretched by rotating and stretching counter-clockwise the supporting rod 11 on the left with pivot 141 as pivot, and rotating and stretching clockwise to the right the supporting rod 12 on the right with pivot 142 as pivot. At this time, with the lower ends of the supporting rods 11 and 12 reaching the ground through rotation, the structure for common supporting frames is thus formed, as shown in FIG. 2B. After using, the supporting frame 1 of the present invention can be disassembled through reversing the aforementioned procedures, thus achieving the purpose of folding the supporting frame 1 after use.

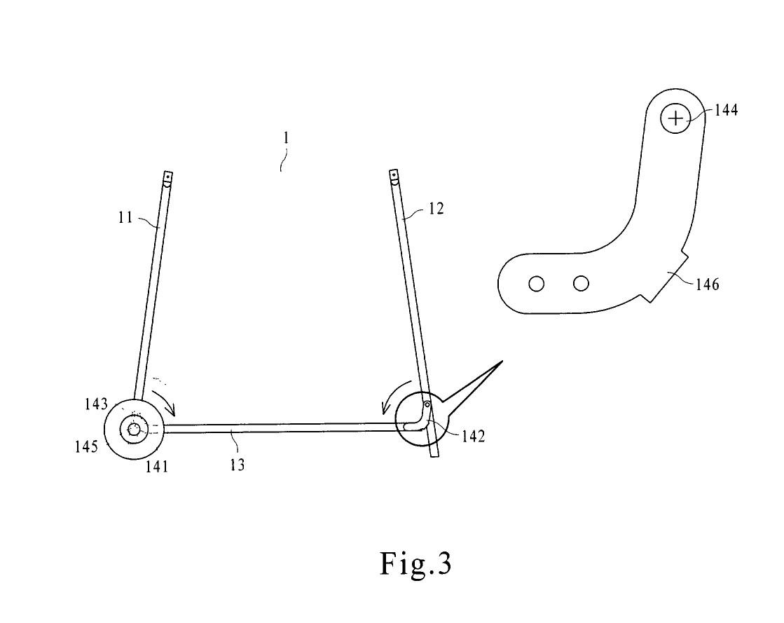

The first embodiment of the supporting frame 1 of the present invention is shown in FIG. 3 in accordance with FIG. 2A and 2B. The pivots 141 and 142, used to pivotally joint the connecting rod 13 with the supporting rods 11 and 12 respectively, are L-shaped pivots oppositely facing each other on the left and on the right. The L-shaped pivots 141 and 142 both comprise a pair of chip-shaped units symmetrical to each other, which are jointed by the aligning portions 145 and 146, and such aligning portions are also used as the stopping devices against the supporting rods 11 and 12 when stretching. The right end of the pivot 141 is fixatedly jointed to the connecting rod 13, and the supporting rod 11 is to be fitted between the two chip-shaped units of the pivot 141, with a pivot bolt 143 to pierce through and align. The rear side of the present invention is a mirror symmetry structure of the front side, therefore it is no need to be described here. The supporting rod 11, with a pair of pivots 143 opposite to each other on the front and rear side as pivot, is to be folded by being rotated clockwise (as shown by the arrow of solid line in FIG. 3). While stretching, the supporting rod 11 is to be stretched by being rotated counterclockwise (as shown by the arrow of dotted line in FIG. 3), and after being stretched, the lower ends of the supporting rod 11 reach the ground and thus form the supporting legs; in addition, the aligning portion 145 is to work as the stopping and aligning mechanism of the supporting rod 11, so as to prevent the supporting rod 11 from overstretching.

The supporting rod 12 and the pivot 142, and the supporting 11 and the pivot 141 are facing one another correspondingly; the left end of the pivot 142 is fixated to the connecting rod 13, and the supporting rod 12 is to be fitted between the two chip-shaped units of the pivot 142, with the pivot bolt 144 to pierce through and align. Therefore, when folding, the supporting rod 12 can be rotated counterclockwise (as shown by the arrow of solid line in FIG. 3) with the pivot bolt 144 as pivot; when stretching, the supporting rod 12 can be rotated clockwise (as shown by the arrow of dotted line in FIG. 3), and the lower ends of the supporting rod 12 thus reach the ground and form the supporting legs. In addition, the aligning portion 145 is to work as the stopping and aligning mechanism of the supporting rod 11, so as to prevent the supporting rod 11 from overstretching.

The length of the pivot 142 is longer than that of the pivot 141, and the position of the pivot 144 is higher than that of the corresponding pivot 143, thus when the supporting rods 11 and 12 are to be folded inward, the supporting rod 12 is to be on top of the supporting rod 11.

The foldable supporting frame 1 of the present invention is further installed with a strengthening device to strengthen the structure of the foldable supporting frame 1 of the present invention, thus the degree of resistance to force by the foldable supporting frame 1 can be increased. The strengthening device can be installed between the two supporting rods 11 and 12 for supporting the supporting frame structure when the supporting rods 11 and 12 are fully stretched outwardly.

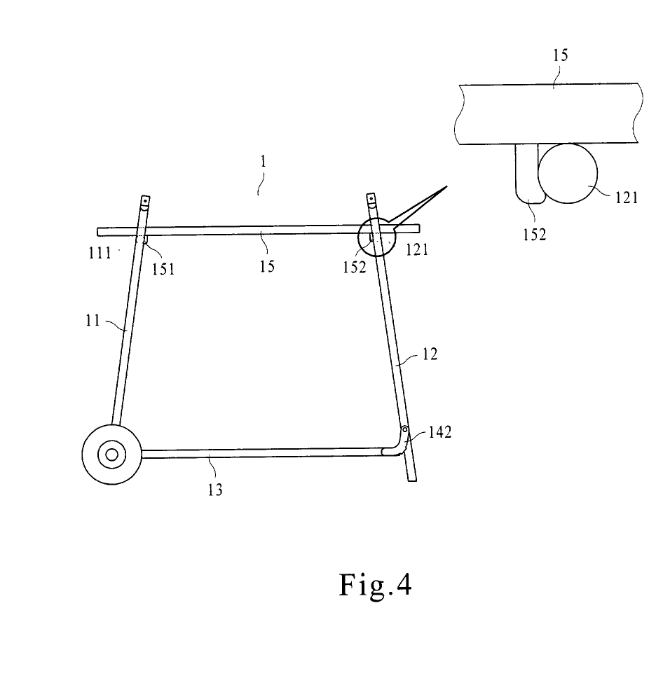

FIG. 4 shows the perspective view of the second embodiment of the foldable supporting frame 1 of the present invention. This embodiment of the foldable supporting frame 1 utilizes the strengthening frame 15 as a strengthening device; the strengthening frame 15 is integrally formed frame, with the stopping portions 151 and 152 installed at the lower part of the strengthening frame 15. Thus when the foldable supporting frame 1 is fully stretched, the user can place the left end of the strengthening frame 15 on top of the crossbar 111 of the supporting rod 11, with the stopping portion 151 propping against the crossbar 111; at this time, the user can further utilizes the crossbar 111 as a fulcrum to lower the strengthening frame 15, and the protruding portion of the lower end of the stopping portion 152 is to come into contact with the crossbar 121, and then the user presses the strengthening frame 15 so as to make the stopping portion 152 smoothly slide down and prop against the supporting rod 12. Therefore, the stopping portion 151 and 152 are respectively propped against the crossbars 111 and 121, thus forming the strengthening structure for the foldable supporting frame 1. This embodiment of the foldable supporting frame 1 employs the strengthening frame 15 to hold the fully stretched supporting rods 11 and 12 and to prevent the supporting rods 11 and 12 from folding inward and collapsing, thus forming the aligning device; also with the strengthening frame 15, the degree of resistance to force by the foldable supporting frame 1 can be increased.

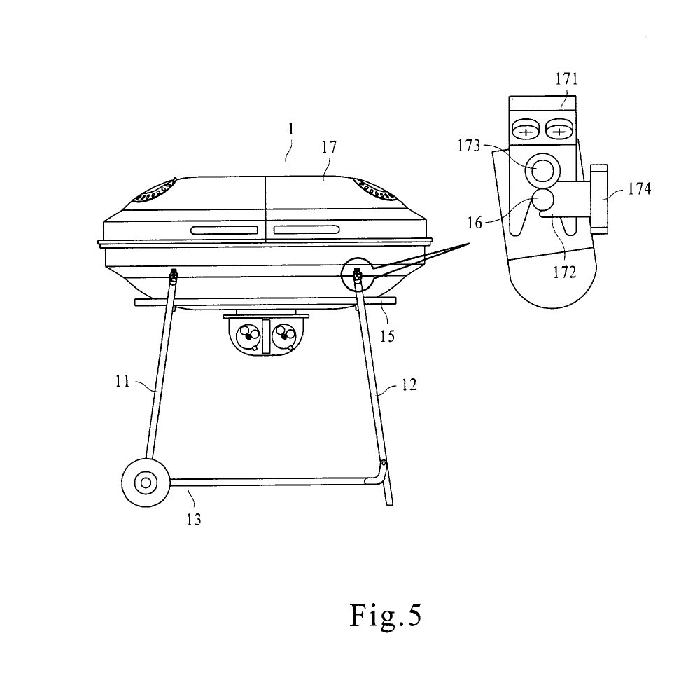

FIG. 5 shows the perspective view of the third embodiment of the foldable supporting frame of the present invention. The present invention can further joint with a grill body 17; on top of the supporting rods 11 and 12 fixating bolts 16 are installed, which are of a rod-like structure, each with one end fixated to the supporting rods, and the other end forming a free end. At the lower part of the grill body 17, jointing portions 171, which are narrow reversed-V-shape grooves on top of which arc-shaped structures are formed, are installed in accordance with the positions of the fixating bolts 16. Thus, when the grill body 17 is placed on top of the foldable supporting frame 1, the fixating bolts 16 of the foldable supporting frame 1 are to enter into the narrow reversed-V-shape grooves of the grill body 17 until the fixating bolts 16 reach the bottom of the narrow reversed-V-shape grooves of the grill body 17 and fall into the arc-shaped portions. Thus the four corners of the grill body 17 can be fixated and supported by four sets of fixating bolts 16.

Please continue referring to FIG. 5. The jointing portions 171 of the grill body 17 are furthered installed with locking chips 172, which are L-shaped chip structures, on the top end of each a pivoting portion 173 is installed to joint with the jointing portion 171 of the grill body. A pushing/holding chip 174 is installed at the lower end of each locking chip 172, and on the corresponding side of each pushing/holding chip 174 an arc-shaped opening is formed. Thus, after the grill body 17 is installed on top of the fixating bolts 16 of the foldable supporting frame 1, the user can push and press the pushing/holding chips 174 to rotate the locking chips 172 with the pivoting portions 173 as pivots, and then the arc-shaped openings are to come into contact with the fixating bolts 16, thus forming the aligning mechanism for the grill body 17 from the side. The two symmetrical locking chips 172 are installed on each jointing portion 171 of the grill body 17, so the aligning mechanism is clampingly formed from both left and right sides.

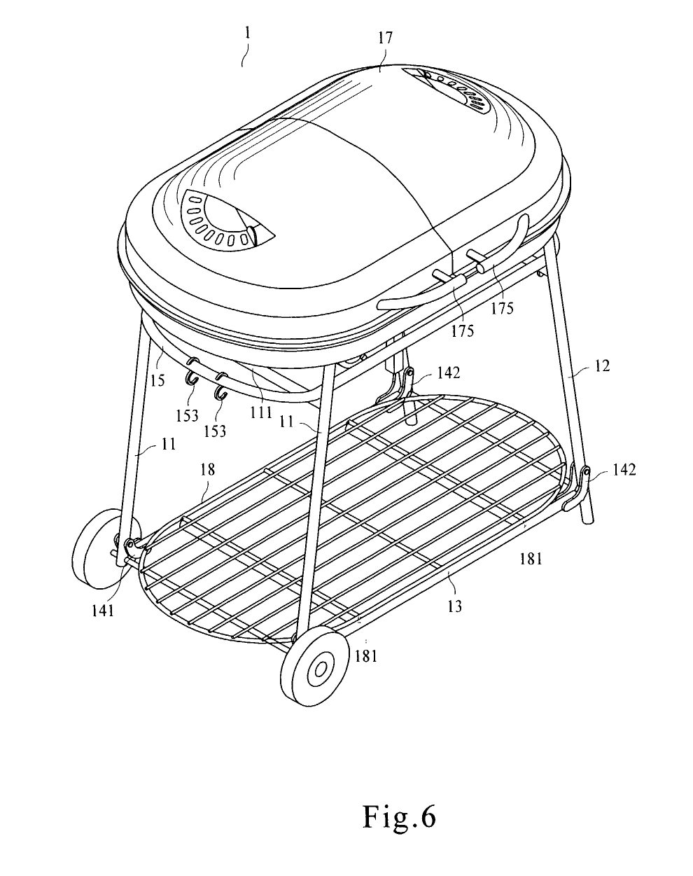

FIG. 6 shows a structural perspective view of another embodiment of the foldable supporting frame 1 of the present invention, wherein the main structure of the foldable supporting frame 1 includes the supporting rods 11 and 12 jointed on both sides of the connecting rod 13; when the supporting rods 11 and 12 are fully stretched respectively toward both sides, the strengthening frame 15 can be installed on top of the supporting rod 11 and the crossbar 111, and the supporting rod 12 and the crossbar 121, consequently the stopping portions 151 and 152 can respectively prop against the crossbar 111 and 121, thus forming a strengthened supporting frame. At this time, the grill body 17 can be installed on top of the fully stretched supporting rods 11 and 12, having the jointing portions 171 to contain the fixating bolts 16 and fix together, and further, by pushing and pressing the pushing/holding portions 174 of the locking chips 172, the locking chips 172 can be steadily locked with the fixating bolts 16, thus locking the grill body on top of the foldable supporting frame 1.

The present invention can be further installed with a grid 18, on the lower side of which a multiple of protruding portions 181 are installed, while a multiple of aligning holes corresponding to the multiple of protruding portions 18 are installed on the upper side of the connecting rod 13, thus when the grid 18 is placed on top of the connecting rod 13, the multiple of protruding portions 181 of the grid 18 can be inserted into the multiple of aligning holes of the connecting rod 13, therefore forming a flat surface for users to place accessories. As a result, the user, while barbequing, can place food items, sauces and other tools or material on the grid 18. A multiple of hanging holes are to be installed on the crossbars of the strengthening frame 15 in the foldable supporting frame 1 of the present invention, so that a multiple of hooks 153 can be hung on such hanging holes to hang food items.

Furthermore, sliding wheels can be further installed at the lower ends of the supporting rod 11, forming the present invention as a cart-like structure; thus when lifting the supporting rod 12 off the ground, the user can push and move the foldable supporting frame 1 by the rotation of such sliding wheels.

The handles 175 are installed on the grill body 17 of the present invention, providing the user with force-application points for moving, installing and storage, so that the user shall not be burned by the overheated grill body 17 after use. Also by pushing the pushing/holding portions 174 installed on the locking chips 172, thus releasing the fixation points between grill body 17 and the foldable supporting frame 1, the user can remove the grill body 17 from top of the foldable supporting frame 1 without being burned; therefore the safety of the grill set can be effectively improved.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

What is claimed is:

1. A foldable supporting frame, comprising:
a connecting rod, which is of a frame-like structure; and
two sets of supporting rods, which respectively joint the two ends of said connecting rod, thus said supporting rods can be rotated with the jointing areas as pivots, consequently forming a supporting frame structure by folding inwardly or stretching outwardly.

2. A foldable supporting frame as in claim 1, wherein said connecting rod and said supporting rods are to be jointed respectively to the two ends of L-shaped pivots; each of said L-shaped pivots mainly comprises two chip-shaped units; said chip-shaped units are to be jointed by an aligning portion, which is also to be used as a stopping device when said supporting rods are fully stretched; said connecting rod and said supporting rods are to be jointed respectively to the two ends of said L-shaped pivots, and the fixating ends are formed at the connecting areas of said connecting rod and said L-shaped pivots, and the rotating ends are formed at the connecting areas of said supporting rods and said L-shaped pivots; when said supporting rods are to be stretched to a set-up angle, said supporting rods are to come into contact with the ends of said connecting rod, thus an aligning mechanism is formed.

3. A foldable supporting frame as in claim 1, further including a strengthening frame; at least two stopping portions are installed on the lower side of said strengthening frame; crossbars are installed on the tope ends of said supporting rods, so that when said supporting frame is fully stretched, said strengthening frame can be installed on top of said crossbars of said supporting rods, thus said stopping portions can respectively prop against said crossbars toward the two sides.

4. A foldable supporting frame as in claim 1, further including a grill body; fixating bolts are installed on the top ends of said supporting rods, and the jointing portions, which are of reversed-V-shape structures, are installed on the lower side of said grill body corresponding to the positions of said fixating bolts; when said grill body are placed on said supporting frame, said fixating bolts can be led by said reversed-V-shape structures of said jointing portions, thus said fixating bolts are to prop against the top of said reversed-V-shape structures of said jointing portions, consequently said grill body can be supported and fixed by said fixating bolts.

5. A foldable supporting frame as in claim 4, wherein a locking chip is further installed on each of said jointing portion; said locking chip is of an L-shaped chip unit, on the top side edge of which is jointed with said jointing portion by a pivoting portion, and on the lower side of which a pushing/holding chip is installed, and an arc-shaped opening is installed opposite to said pushing/holding chip, thus when said grill body is installed on top of said fixating bolts, the user can press said pushing/holding chips, so that said locking chips can be rotated by using the pivoting portions as pivots, and, with said arc-shaped openings propping against said fixating bolts, an aligning mechanism from the side is formed.

6. A foldable supporting frame, comprising:
a connecting rod, which is of a frame-like structure;
two sets of supporting rods, which respectively joint the two ends of said connecting rod, thus said supporting rods can be rotated with the jointing areas as pivots, consequently forming a supporting frame structure by folding inwardly or stretching outwardly; and
a strengthening device, installed in between two sets of said supporting rods, for supporting the supporting frame structure of said supporting rods being stretched outward.

7. A foldable supporting frame as in claim 6, wherein said strengthening device is of a strengthening frame, having the lower side of which installed with at least two stopping portions; crossbars are installed on the top ends of said supporting rods, thus when said supporting frame is fully stretched, said strengthening frame can be placed on top of said crossbars of said supporting rods, consequently said stopping portions can respectively prop against said crossbars of said supporting rods.

8. A foldable supporting frame, comprising:
a connecting rod, which is of a frame-like structure, on the top ends of which fixating bolts are installed;
two sets of supporting rods, which are used as supporting legs when said supporting frame is stretched outward;
L-shaped pivots, comprising mainly chip-shaped units symmetrical in terms of the front and the rear sides, which are jointed by aligning portions that are also functioned as stopping devices when said supporting rods are fully stretched; said connecting rod and said supporting rods are respectively jointed on the two ends of said L-shaped pivots, with the jointing areas of said connecting rod and said L-shaped pivot being the fixated ends, and with the jointing areas of said supporting rods and said L-shaped pivot being the rotating ends, thus said supporting rods, when stretched to a set-up angle, can prop against the ends of said connecting rod to form an aligning mechanism;
a strengthening device, installed in between two sets of said supporting rods, for supporting the supporting frame structure of said supporting rods being stretched outward;
a grill body, with jointing portions, which are of narrow reversed-V-shape groove structures, installed on the lower part corresponding to the positions of said fixating bolts, and on top of said narrow reversed-V-shape grooves arc-shaped structures are formed; thus said narrow reversed-V-shape grooves, when said grill body is placed on the top side of said supporting frame, can be used to guide said fixating bolts to slide into the bottom sides of said narrow grooves, and fall into said arcs installed at the bottoms of said narrow grooves; consequently said grill body can be supported and fixated by said fixating bolts; and
a grid, with a multiple of protruding portions installed on the lower side, and aligning holes are installed at the positions corresponding to those of said protruding portions, thus when said grid is placed on top of said connecting rod, said protruding portions can be inserted into said aligning holes, consequently forming a flat surface to place accessories.
